(19) United States
(12) Patent Application Publication
(10) Pub. No.: US 2013/0170937 A1
(43) Pub. Date: Jul. 4, 2013

(54) DIE PICKUP DEVICE WITH RING-SHAPED HANDLE PORTION AND DIE BOND SYSTEM INCLUDING SAME

(71) Applicant: YI-ZHONG SHEU, Tu-Cheng (TW)

(72) Inventor: YI-ZHONG SHEU, Tu-Cheng (TW)

(21) Appl. No.: 13/661,037

(22) Filed: Oct. 26, 2012

(30) Foreign Application Priority Data
Dec. 30, 2011 (TW) 100149691

(51) Int. Cl. B65G 49/00

(52) U.S. Cl. 414/752.1; 414/751.1

(57) ABSTRACT

Provided is a die pickup device for picking up a die from a wafer and putting the die on a substrate. The die pick device includes a pickup head for picking up the die, a handle portion and a connecting portion connected between the pickup head and the handle portion. The handle portion is substantially ring-shaped and defines a central opening. An end of the connecting portion connected to the pickup head faces toward a center of the central opening.

### BACKGROUND

1. Technical Field

The present disclosure relates to a die pickup device and a die bond system having the die pickup device.

2. Description of Related Art

A die bond system includes a supporting base, a die pickup device, and a position detector. In operation, a die is supported on the supporting base. The die pickup device picks up a die from a wafer and places the die on the substrate. The position detector detects the position of the die and calculates an offset between the position and a predetermined position of the die. The die pickup device adjusts the die to the predetermined position. The die pickup device typically includes a pickup head and a handle portion connected to the pickup head. The handle portion is usually larger than the pickup head and the die, and thus the position detector which is typically positioned above the handle portion may not clearly and accurately detect the position of the die. Thus, detection accuracy of the position detector is adversely affected. Therefore, the die pickup device should be moved away from the during the position detection of the die. Furthermore, in adjusting the die, the die pickup device will be moved to the die again. That is inconvenient and inefficient.

What is needed therefore is a die pickup device and die bond system addressing the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic view of a die bond system, according to an exemplary embodiment of the present disclosure.

FIG. 2 is similar to FIG. 1, but showing the die bond system in use.

### DETAILED DESCRIPTION

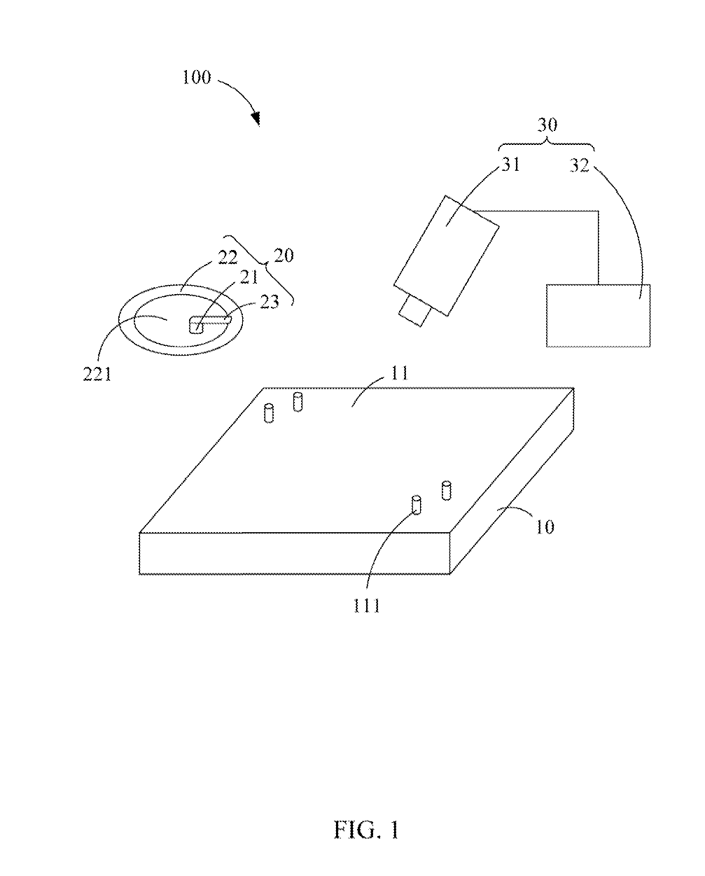

Referring to FIG. 1, a die bond system 100, according to an exemplary embodiment, is shown. The die bond system 100 includes a supporting base 10, a die pickup device 20, and a position detector 30.

The supporting base 10 is configured for supporting and positioning a substrate (not shown) thereon. The supporting base 10 includes an upper surface 11 and a number of the positioning poles 111 located on the upper surface 11. The positioning poles 111 are configured for determining an position of the substrate on the upper surface 11 and keeping the substrate at the position.

The die pickup device 20 is configured for picking up a die (not shown) from a wafer (not shown) and putting the die at a predetermined bonding position on the substrate. The die pickup device 20 includes a pickup head 21, a handle portion 22 and a connecting portion 23 connected between the pickup head 21 and the handle portion 22.

The pickup head 21 is configured for picking up the die. In this embodiment, the pickup head 21 is a vacuum suction nozzle.

The handle portion 22 is substantially ring-shaped. In detail, the handle portion 22 is formed by curving a straight rod and connecting the rod end to end, thus the handle portion 22 defines a central opening 221. In this embodiment, a shape of the handle portion 22 is substantial a circular ring. Alternatively, the shape of the handle portion 22 can be rectangular ring, triangular ring, oval ring, etc. The handle portion 22 can be connected to a manipulator (not shown), to automatically pick up the die.

The connecting portion 23 is substantial a straight bar. One end of the connecting portion 23 is connected to the pickup head 21, and the other end of the connecting portion 23 is connected to the handle portion 22. The end of the connecting portion 23 connected to the pickup head 21 faces toward a center of the central opening 221.

The position detector 30 is positioned over the supporting base 10. The position detector 30 includes a sensor 31 and a processor 32 connected to the sensor 31. The sensor 31 is configured for detecting a position of the die on the substrate. In this embodiment, the sensor 32 is an infrared sensor. The processor 32 is configured for determining an offset of the die relative to a predetermined mounting position of the die according to the detecting result of the sensor 31.

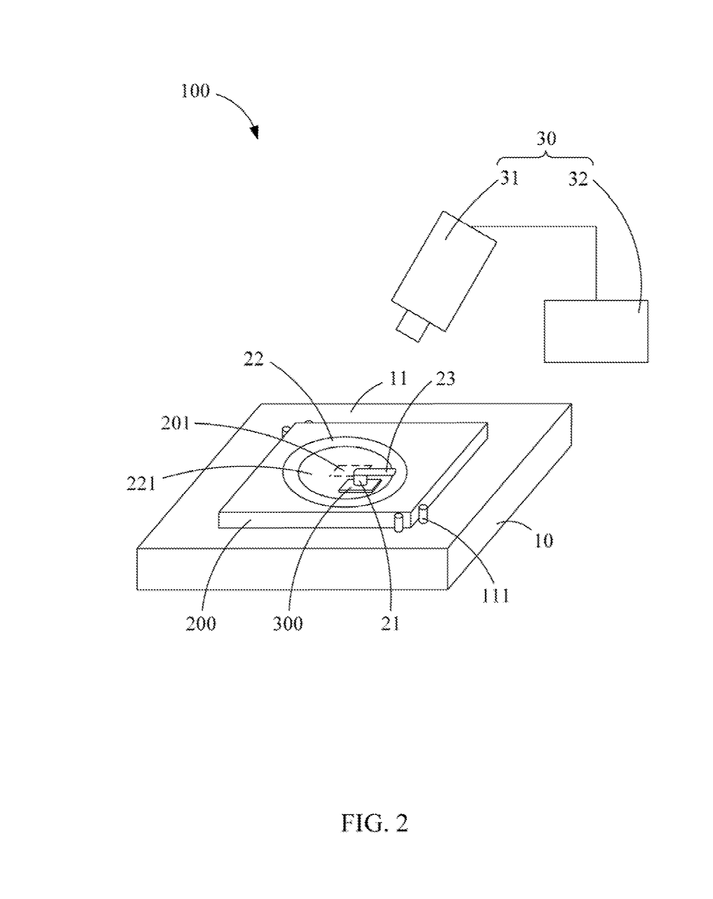

Referring to FIG. 2, in use, a substrate 200 is positioned on the top surface 11 of the supporting base 10. The positioning poles 111 resist on edges of the substrate 200, to keep the substrate 200 at a proper position on the supporting base 10. The substrate 200 includes at least one predetermined mounting position 201 for mounting a die. The die pickup device 20 picks up a die 300 from a wafer and puts the die 300 on the substrate 200. The sensor 31 detects a position of the die 300 on the substrate 200. The processor 32 determines an offset of the die 300 relative to the predetermined mounting position 201 according to the detecting result of the sensor 31. The die pickup device 20 adjusts the position of the die according to the offset determined by the processor 32. Such position detecting, offset determining and position adjusting steps can be repeated until the die 300 is properly positioned at the predetermined mounting position 201. Finally, the die 300 is bonded at the predetermined mounting position 201 of the substrate 200.

Because the handle portion 22 of the die pickup device 20 is ring-shaped, the sensor 31 can directly detect the position of the die 300 through the central opening 221 of the handle portion 22. Therefore, the die pickup device 20 need not to move away from the die 300 during the position detecting process, and can directly adjust the position of the die 300 after the offset determining process. Therefore, it is convenient and efficient to bond the die 300 to the substrate 200 using the die pickup device 20 and the die bond system 100 with the die pickup device 20.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A die pickup device for picking up a die from a wafer and putting the die on a substrate, comprising:
a pickup head for picking up the die;
a handle portion, the handle portion being substantially ring-shaped and defining a central opening; and
a connecting portion connected between the pickup head and the handle portion, an end of the connecting portion connected to the pickup head facing toward a center of the central opening.

2. The die pickup device of claim 1, wherein the pickup head is a vacuum suction nozzle.

3. The die pickup device of claim 1, wherein the handle portion is in a shape selected from the group consisting of circular ring, rectangular ring, triangular ring and oval ring.

4. A die bond system for bonding a die to a substrate, comprising:
a supporting base for supporting and positioning the substrate;
a die pickup device for picking up the die from a wafer and putting the die on the substrate, comprising:
a pickup head for picking up the die;
a handle portion, the handle portion being substantially ring-shaped and defining a central opening; and
a connecting portion connected between the pickup head and the handle portion, an end of the connecting portion connected to the pickup head facing toward a center of the central opening; and
a position detector positioned over the supporting base and configured for detecting a position of the die on the substrate and determining an offset of the die relative to a predetermined mounting position of the die.

5. The die bond system of claim 4, wherein the position detector comprises a sensor and a processor connected to the sensor, the sensor is configured for detecting the position of the die on the substrate, the processor is configured for determining the offset of the die relative to the predetermined mounting position of the die according to the detecting result of the sensor.

6. The die bond system of claim 5, wherein the sensor is an infrared sensor.

7. The die bond system of claim 4, wherein the supporting base comprises a plurality of positioning poles, and the poles are configured for keeping the substrate at a predetermined position on the supporting base.

8. The die bond system of claim 4, wherein the pickup head is a vacuum suction nozzle.

9. The die bond system of claim 4, wherein the handle portion is in a shape selected from the group consisting of circular ring, rectangular ring, triangular ring and oval ring.
